(19) United States
(12) Patent Application Publication
(10) Pub. No.: US 2023/0147274 A1
(43) Pub. Date: May 11, 2023

(54) METHOD AND APPARATUS FOR RECOMMENDING TABLE SERVICE BASED ON IMAGE RECOGNITION

(71) Applicant: ELECTRONICS AND TELECOMMUNICATIONS RESEARCH INSTITUTE, Daejeon (KR)

(72) Inventors: Woo Han YUN, Daejeon (KR); Do Hyung KIM, Daejeon (KR); Jae Hong KIM, Daejeon (KR); Tae Woo KIM, Daejeon (KR); Chan Kyu PARK, Daejeon (KR); Ho Sub YOON, Daejeon (KR); Jae Yeon LEE, Daejeon (KR); Min Su JANG, Daejeon (KR)

(21) Appl. No.: 17/903,364

(22) Filed: Sep. 6, 2022

(30) Foreign Application Priority Data
Nov. 9, 2021 (KR) 10-2021-0153362
Jul. 7, 2022 (KR) 10-2022-0083669

(51) Int. Cl. G06V 20/68; G06V 10/25; G06V 10/20

(52) U.S. Cl. CPC G06V 20/68; G06V 10/25; G06V 10/255; G06V 2201/07; G06Q 50/12

(57) ABSTRACT

Disclosed herein a method and apparatus for recommending a table service based on image recognition. According to an embodiment of the present disclosure, there is provided a method for recommending a table service, including: receiving a table image that is captured in real time; acquiring, by using an artificial intelligence of a pre-learned learning model, table information that includes object information and food information of at least one table in the table image; and recommending, based on the table information, a service for each of the at least one table.

### CROSS REFERENCE TO RELATED APPLICATIONS

The present application claims priority to Korean patent applications 10-2021-0153362, filed Nov. 9, 2021, and 10-2022-0083669, filed Jul. 7, 2022, the entire contents of which are incorporated herein for all purposes by this reference.

### BACKGROUND OF THE INVENTION

### 1. Field of the Invention

The present disclosure relates to a method and apparatus for recommending a table service based on image recognition, and more particularly, to a table service recommending method and apparatus capable of recommending a table service based on image recognition using artificial intelligence (AI) of a pre-learned learning model.

### 2. Description of Related Art

The existing image-based recognition technologies associated with restaurants include a technology of recognizing foods in an image and then measuring calories of the foods or a technology of recognizing a type of food and then automatically paying for it.

However, there is no technology that recognizes the state of tables in a restaurant, automatically comprehends a service needed by a customer, and then informs a restaurant manager of the service. Such technologies have hardly been used in real service environments because a pre-learned intelligence model applied in actual practice undergoes performance degradation due to the gap between learning data and field data and thus the performance is not as good as expected.

### SUMMARY

A technical object of the present disclosure is to provide a table service recommending method and apparatus capable of recommending a table service based on image recognition using artificial intelligence (AI) of a pre-learned learning model.

Other objects and advantages of the present invention will become apparent from the description below and will be clearly understood through embodiments. In addition, it will be easily understood that the objects and advantages of the present disclosure may be realized by means of the appended claims and a combination thereof.

Disclosed herein a method and apparatus for recommending a table service based on image recognition. According to an embodiment of the present disclosure, there is provided a method for recommending a table service. The method comprising: receiving a table image that is captured in real time; acquiring, by using an artificial intelligence of a pre-learned learning model, table information that includes object information and food information of at least one table in the table image; and recommending, based on the table information, a service for each of the at least one table.

According to the embodiment of the present disclosure, wherein the acquiring of the table information comprises: calculating, by using the artificial intelligence, a target object candidate region from a table image and a reliability of the target object candidate region respectively; determining a target object candidate region with the reliability equal to or greater than a preset model reference value as a detection region; and acquiring, through the detection region, the object information including a location of an object and a type of an object and food information including a food type and a food quantity.

According to the embodiment of the present disclosure, wherein the recommending of the service recommends the service for a corresponding table based on table information of the corresponding table, order information of the corresponding table, and call progress information associated with a call of the corresponding table.

According to the embodiment of the present disclosure, wherein the recommending of the service comprises: when there is no call service for a corresponding table, selecting a recommendable service by comparing table information of the corresponding table and information on at least one preset condition; and providing the selected recommendable service as a service of the corresponding table.

According to the embodiment of the present disclosure, wherein the recommending of the service further comprises recommending at least one service among collecting a plate, collecting wastes, serving a food, providing a refill, and informing a lost item.

According to the embodiment of the present disclosure, the method further comprising: determining whether or not there is a change corresponding to a recommended service or a requested service, based on table information before and after the recommended service or the requested service; and adjusting the model reference value to be lower by a preset first value, when it is determined that there is a change corresponding to the recommended service or the requested service, and adjusting the model reference value to be higher by a preset second value, when it is determined that there is no change corresponding to the recommended service or the requested service.

According to the embodiment of the present disclosure, the method further comprising: collecting relearning data by using service information for each of the at least one table and table information before and after the service corresponding to the service information; and relearning the learning model by using the relearning data, when a predetermined amount of the relearning data is collected, wherein the acquiring of the table information acquires the table information by using the relearned learning model.

According to the embodiment of the present disclosure, wherein the collecting of the relearning data collects the relearning data, when no change corresponds to the service information based on the table information before and after the service corresponding to the service information.

According to the embodiment of the present disclosure, wherein the collecting of the relearning data collects the relearning data by correcting an error in the table information before the service, when no change corresponds to the service information.

According to another embodiment of the present disclosure, there is provided an apparatus for recommending a table service. The apparatus comprising: an image receiver configured to receive a table image that is captured in real time; an image recognition unit configured to acquire, by using an artificial intelligence of a pre-learned learning model, table information that includes object information and food information of at least one table in the table image; and a service recommendation unit configured to recommend, based on the table information, a service for each of the at least one table.

The features briefly summarized above with respect to the present disclosure are merely exemplary aspects of the detailed description below of the present disclosure, and do not limit the scope of the present disclosure.

According to the present disclosure, it is possible to provide a table service recommending method and apparatus capable of recommending a table service based on image recognition using artificial intelligence (AI) of a pre-learned learning model.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view showing a configuration of a table service recommendation device according to an embodiment of the present disclosure.

FIG. 2 is a view showing an example configuration for an image recognition unit.

FIG. 3 is a view showing an example configuration for a relearning data collection unit.

FIG. 4 is a view showing an example of a table image.

FIG. 5 is a view showing an example of table information before and after a service call.

FIG. 6 is a flowchart showing an operation of a table service recommending method according to another embodiment of the present disclosure.

FIG. 7 is a flowchart showing an operation of an embodiment for step S640 of FIG. 6.

FIG. 8 is a view illustrating a device configuration to which a table service recommendation device according to an embodiment of the present disclosure is applicable.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

The embodiments of the present disclosure are directed to provide customers with services suitable for the state of each table by recommending a service for a table based on table recognition using an artificial intelligence of a pre-learned learning model.

Herein, in the embodiments of the present disclosure, as relearning data for relearning of a learning model of an artificial intelligence is selectively collected and the learning model is re-learned using the collected relearning data, stable performance of the learning model for acquiring table information from table images may be provided.

A recommendable table service in embodiments of the present disclosure may include collecting a plate, collecting wastes, serving a food, providing a refill, informing a lost item, and the like.

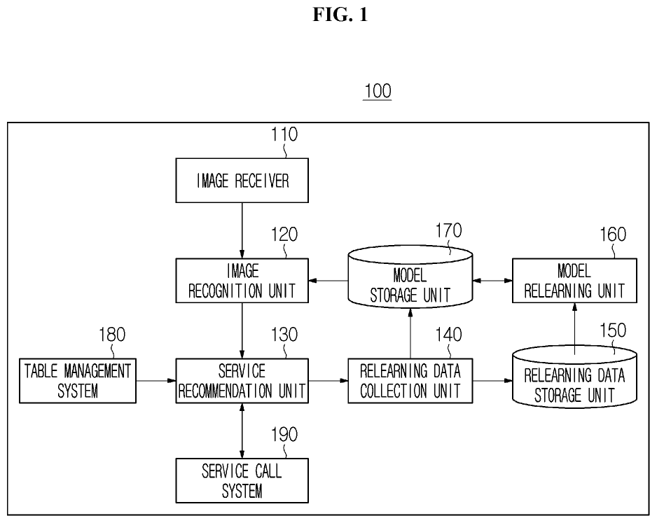

FIG. 1 is a view showing a configuration of a table service recommendation device according to an embodiment of the present disclosure.

Referring to FIG. 1, a table service recommendation device 100 according to an embodiment of the present disclosure includes an image receiver 110, an image recognition unit 120, a service recommendation unit 130, a relearning data collection unit 140, a relearning data storage unit 150, a model relearning unit 160, a model storage unit 170, a table management system 180, and a service call system 190.

Herein, the table management system 180 and the service call system 190 may be systems in the table service recommendation device or be separate systems.

The image receiver 110 is a portion for receiving a table image, for example, a table image of a restaurant and receives a table image, which is captured in real time through an imaging device such as a camera, from the imaging device.

Herein, the image receiver 110 may receive a table image of a corresponding table together with identification information of a corresponding imaging means from each imaging means shooting respective tables and also receive a table image including a plurality of tables through a single imaging means shooting all the tables.

Hereinafter, in an embodiment of the present disclosure, a table image will be described to be an image of a single table, but the embodiments of the present disclosure are applicable to not only a table image for a single table but also to a table image including a plurality of tables, and this is apparent to those who have skill in the art.

As a configuration means of acquiring table information from a table image, in order to acquire table information from a table image, the image recognition unit 120 may use an artificial intelligence of a pre-learned learning model and acquire table information including information on an object on a table (e.g., information on a type and location of the object) and food information (e.g., information on a type and quantity of a food) by using the artificial intelligence of such a learning model.

Herein, the image recognition unit 120 may calculate a target object candidate region from a table image and a reliability of each target object candidate region by using an artificial intelligence, determine a target object candidate region with a reliability, which is equal to or greater than a preset model reference value, as a detection region, and acquire object information including a location of an object and a type of an object and food information including a food type and a food quantity through the detection region.

According to an embodiment, the image recognition unit 120 may acquire table information from a table image by reflecting a preset model reference value. Herein, the model reference value is a value, which becomes a criterion for classifying an object in an image as a preset object, and may be a probability value of a criterion for recognizing a specific object as a specific object, and when the probability value exceeds a model reference value, a corresponding object may be recognized as a specific object. That is, a model reference value may be a reference value for recognizing an object, and such a reference value may be a value for extracting a specific object from an output result by being applied to the output result of a learning model.

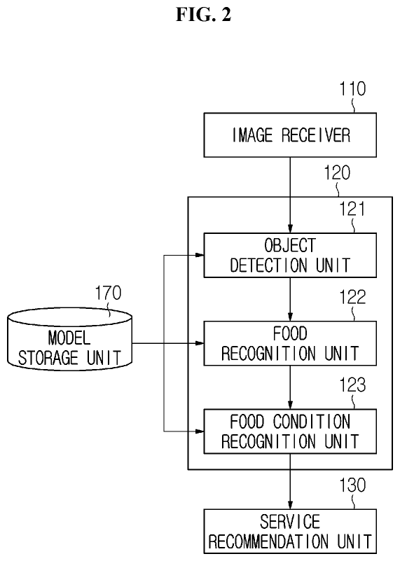

Herein, the model reference value may be received from the model storage unit 170 that stores a learning model of an artificial intelligence. As illustrated in FIG. 2, the image recognition unit 120 may include an object detection unit 121, a food recognition unit 122, and a food condition recognition unit 123.

The object detection unit 121 recognizes a location and type of an object in a table image, which is received through the image receiver 110, by using a learning model and a preset model reference value received from the model storage unit 170. Herein, a learning model of the object detection unit 121 may calculate a target object candidate region and a reliability and determine only a candidate region equal to or greater than a model reference value as a detection region.

Examples of objects to be detected for a table service may include food and beverage (e.g., foods, drinks), tablewares (e.g., spoons, chopsticks, forks, knives, scissors, tongs, plates, cups), personal belongings (e.g., cell phones and wallets), wastes and the like. In the case of a location of an object, a coordinate of a region of an object is represented in pixel units.

Herein, the object detection unit 121 may be embodied in a deep learning algorithm such as RPN and FRCN of Faster RCNN.

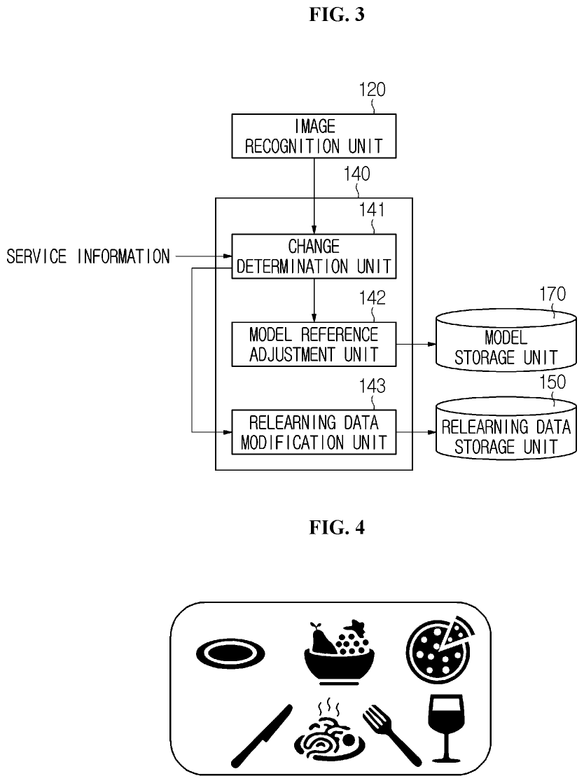

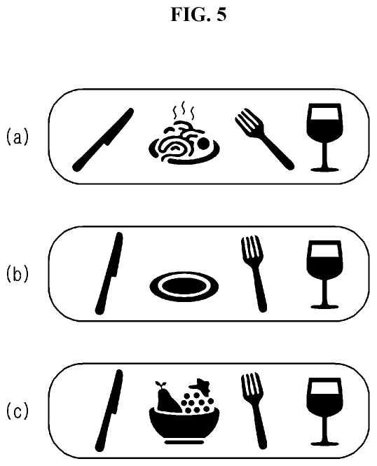

For example, when the table image as illustrated in FIG. 4 is received, the object detection unit 121 detects object information including object types like a plate, 3 foods, a knife, and a drink, which are included in a table image like Table 1 below, and location information for each object type.

TABLE 1

| | | | LOCATION |
|---|---|---|---|
| IMAGE | ORDER | OBJECT TYPE | (x1, y1, x2, y2) |
| [symbol] | 1 2 3 4 5 | TABLEWARE (PLATE) FOOD AND BEVERAGE (FOOD) FOOD AND BEVERAGE (FOOD) TABLEWARE (KNIFE) FOOD AND BEVERAGE (FOOD) | 50, 50, 80, 70 100, 30, 120, 90 130, 28, 160, 95 . . . . . . |
| | 6 | TABLEWARE (FORK) | . . . |
| | 7 | FOOD AND BEVERAGE (BEVERAGE) | . . . |

The food recognition unit 122 is a configuration means of recognizing a food or a type of a food, when an object type from object information detected by the object detection unit 121 is a drink or a food, and an example of recognition may include pizza, pasta, Coke, Sprite, water and the like, and a type to be recognized may be determined in a prelearning process of a learning model. Of course, a food or a food type to be recognized may be determined by a provider or an individual providing a technology according to an embodiment of the present disclosure.

Herein, the food recognition unit 122 may be embodied by a classification and regression deep learning algorithm of machine learning.

For example, the food recognition unit 122 may recognize types of foods or drinks among types of objects detected by the object detection unit 121, as shown in Table 2 below, and convert a table image into object information including a type and a location of an object and information on a food type.

TABLE 2

| | | | LOCATION | FOOD |
|---|---|---|---|---|
| IMAGE | ORDER | OBJECT TYPE | (x1, y1, x2, y2) | TYPE |
| [symbol] | 1 2 3 4 5 | TABLEWARE (PLATE) FOOD AND BEVERAGE (FOOD) FOOD AND BEVERAGE (FOOD) TABLEWARE (KNIFE) FOOD AND BEVERAGE (FOOD) | 50, 50, 80, 70 100, 30, 120, 90 130, 28, 160, 95 . . . . . . | FRUIT PIZZA PASTA |
| | 6 | TABLEWARE (FORK) | . . . | |
| | 7 | FOOD AND BEVERAGE (BEVERAGE) | . . . | |

As a configuration means of recognizing a food quantity (e.g., a quantity of drink, a quantity of pizza) using a learning model, the food condition recognition unit 123 may recognize a condition for a food quantity and provide a value in a predetermined range, for example, a value ranging from 0 to 100%, when the object types detected by the object detection unit 121 are beverage, food, plate and cup.

Herein, the food condition recognition unit 123 may also be embodied by a classification and regression deep learning algorithm of machine learning.

For example, for food or beverage among object types recognized by the object detection unit 121 and the food recognition unit 122 as shown in Table 3 below, the food condition recognition unit 123 recognizes a quantity of a leftover food or drink and finally outputs table information including object information and food information. That is, in the table image of FIG. 4, the image recognition unit 120 may acquire table information as shown in Table 3 below.

TABLE 3

| | | | LOCATION | FOOD | |
|---|---|---|---|---|---|
| IMAGE | ORDER | OBJECT TYPE | (x1, y1, x2, y2) | TYPE | QUANTITY |
| [symbol] | 1 2 3 4 5 | TABLEWARE (PLATE) FOOD AND BEVERAGE (FOOD) FOOD AND BEVERAGE (FOOD) TABLEWARE (KNIFE) FOOD AND BEVERAGE (FOOD) | 50, 50, 80, 70 100, 30, 120, 90 130, 28, 160, 95 . . . . . . | FRUIT PIZZA PASTA | 0 90 95 90 |
| | 6 | TABLEWARE (FORK) | . . . | | |
| | 7 | FOOD AND BEVERAGE (BEVERAGE) | . . . | | 60 |

That is, as described above, the image recognition unit 120 may acquire table information, which includes a type and a location of an object on a table and a type and a quantity of a food, by using an artificial intelligence of a learning model and provide the table information thus acquired to the service recommendation unit 130 and the relearning data collection unit 140 through the service recommendation unit 130.

The service recommendation unit 130 recommends at least one service suitable for each table based on table information that is acquired by the image recognition unit 120. Herein, a recommended service may include at least one of collecting a plate, collecting wastes, serving a food, providing a refill, and informing a lost item.

According to an embodiment, the service recommendation unit 130 may recommend a service for a table based on table information of the table, order information of the table and call progress information associated with a call of the table. Herein, the order information of the table may be received through the table management system 180, and the call progress information may be received through the service call system 190. The call process information may have any one value among values corresponding to no call, service call in progress, and completion of service call.

According to an embodiment, when there is no call service by a table, the service recommendation unit 130 may select a recommendable service by comparing table information of the table and information on at least one preset condition and provide the recommendable service thus selected as a service of the table.

Specifically, when table information is input, the service recommendation unit 130 first checks, in the service call system 190, whether or not a service has ever been called before. Herein, call progress information may have one of three values, that is, any one value of no call (0), service call in progress (1), and completion of service call (2). When the call progress information corresponds to no call (0), the service recommendation unit 130 compares at least one preset condition to recommend a service while no separate service is being called. In addition, when call progress information corresponds to service call in progress (1), the service recommendation unit 130 suspends a current process until completion of call (2) is received and receives an input of a next image. In addition, when call progress information corresponds to completion of call (2), the service recommendation unit 130 immediately forwards input table information to the relearning data collection unit 140 in the name of table information after call 212. Herein, the completion of call (2) is converted to no call (0) after a predetermined time.

When no service is called, the service recommendation unit 130 may select a service to be recommended by referring to contents of table information and a table of preset conditions, for example, the conditions of the look-up table in Table 4 below.

TABLE 4

| | | CONDITION 1 | | CONDITION 2 | | | |
|---|---|---|---|---|---|---|---|
| SERVICE | RECOMMENDED | | QUANTITY OF | TIME | PAY- | TYPE OF | AVAILABILITY |
| NUMBER | SERVICE | TYPE OF OBJECT | LEFTOVER | ELAPSED | MENT | ORDER | OF REFILL |
| 1 | COLLECT PLATE | FOOD/DRINK/CUP/PLATE | <10% | >1 MIN | — | COURSE MEAL | NOT AVAILABLE |
| | AND SERVICE | | | | | | |
| | NEXT FOOD | | | | | | |
| 2 | COLLECT PLATE | FOOD/DRINK/CUP/PLATE | <10% | >1 MIN | — | NOT COURSE | NOT AVAILABLE |
| | | | | | | MEAL | |
| 3 | PROVIDE REFILL | FOOD/DRINK/CUP/PLATE | <10% | >1 MIN | — | — | AVAILABLE |
| 4 | COLLECT WASTES | WASTES | — | >1 MIN | — | — | — |
| 5 | INFORM LOST ITEM | PERSONAL BELONGING | — | — | PAID | — | — |

For example, when table information is input as shown in Table 3 above, since the object 1 is tableware (plate) and its quantity is 0 in Table 3, the service numbers 1, 2 and 3 among the service numbers of Table 4 satisfy Condition 1 so that table information and time are recorded in a cache as candidates of the service numbers 1, 2 and 3. Next, it is checked after some time whether or not table information extracted from a new input image, that is, a table image satisfies Condition 1 and Condition 2. Condition 2 checks an elapsed time, payment, type of order, and availability of refill, and this information may be obtained or received from the table management system 180 through order information. When table information obtained as in Table 3 continues over 1 minute, Condition 2 is satisfied so that, depending on a type of order and availability of refill, collecting a plate and serving a next food, collecting a plate, and serving a refill may be selected as recommendable services. A service number thus selected is forwarded to the relearning data collection unit 140 together with table information before call stored in a cache. In addition, the service number is forwarded to the service call system 190.

Table 5 below shows table information before call and an example service number, and when the information on type of order or availability of refill in Condition 2 of Table 4 above is not accessible, such cases may be unified into the service of collecting a plate, which is a representative service.

TABLE 5
TABLE INFORMATION BEFORE CALL

| | | | LOCATION | FOOD | | SERVICE |
|---|---|---|---|---|---|---|
| IMAGE | ORDER | OBJECT TYPE | (x1, y1, x2, y2) | TYPE | QUANTITY | NUMBER |
| [symbol] | 1 | TABLEWARE (PLATE) | 50, 50, 80, 70 | | 0 | 2 |
| | 2 | FOOD AND | 100, 30, 120, 90 | FRUIT | 90 | |
| | | BEVERAGE (FOOD) | | | | |
| | 3 | FOOD AND | 130, 28, 160, 95 | PIZZA | 95 | |
| | | BEVERAGE (FOOD) | | | | |
| | 4 | TABLEWARE (KNIFE) | . . . | | | |
| | 5 | FOOD AND | . . . | PASTA | 95 | |
| | | BEVERAGE (FOOD) | | | | |
| | 6 | TABLEWARE (FORK) | . . . | | | |
| | 7 | FOOD AND BEVERAGE | . . . | | 60 | |
| | | (BEVERAGE) | | | | |

Of course, the information of conditions like in Table 4, which is used in the service recommendation unit 130, may change according to situations or order information, and such information of conditions may be determined a provider or an individual who provides an embodiment of the present disclosure.

The table management system 180 is a system for recording/managing a name of menu ordered from a table, a type of order (course meal or not), availability of refill, whether payment is made or not, and the like, and the system may utilize an existing POS system.

The service call system 190 is a system for receiving a service number, which is information on a recommended service, informing a hall manager with the service number and monitoring the progress, and when there is a request from the service recommendation unit 130, provides call progress information of the recommended service. Herein, the call progress information may include information regarding whether or not there is a recommended service that is currently called, whether or not it is being called, and whether or not it is completely called (e.g., a hall manager/clerk completely provides a service to a corresponding table).

Being a configuration means of collecting relearning data for relearning of a learning model of the image recognition unit 120, the relearning data collection unit 140 collects relearning data by using service information for at least one table and table information before and after a service corresponding to the service information.

Herein, based on table information before and after a service corresponding to service information, the relearning data collection unit 140 may collect relearning data, when a change does not correspond to the service information, and collect relearning data by modifying an error in the table information before a service, when a change does not correspond to the service information.

Furthermore, based on table information before and after a recommended service or a requested service, the relearning data collection unit 140 may determine whether or not there is a change corresponding to the recommended service or the requested service, and when it is determined that there is a change corresponding to the recommended service or the requested service, the relearning data collection unit 140 may lower a model reference value by a preset first value, and when it is determined that there is no change corresponding to the recommended service or the requested service, the relearning data collection unit 140 may raise the model reference value by a preset second value.

Specifically, the relearning data collection unit 140 generates relearning data and information on model reference value adjustment by using table information before call, a service number and table information after call. As illustrated in FIG. 3, the relearning data collection unit 140 includes a change determination unit 141, a model reference adjustment unit 142, and a relearning data modification unit 143. The change determination unit 141 determines whether or not a service call is appropriate, based on a difference of table information before and after call and information on a recommended service. The model reference adjustment unit 142 adjusts a reference value of a model based on a determination result of the change determination unit 141 and provides the reference value to the model storage unit 170, and based on a determination result of the change determination unit 141, the relearning data modification unit 143 collects and stores relearning data in the relearning data storage unit 150 or modifies at least a part of collected relearning data and stores relearning data including modified data in the relearning data storage unit 150.

According to an embodiment, the change determination unit 141 determines whether a change of table information is an intended change or not an intended change, based on a preset type classification condition table, a difference of table information before and after call and information on a recommended service. Herein, the change determination unit 141 may determine whether a change of table information is an intended change or not an intended change, by using the type classification condition table of Table 6 below. The change determination unit 141 may determine an intended change only when all the conditions marked with “0” are satisfied in Table 6 below. As an example, when it is assumed that, in table information before call, the quantity of leftover food is 10% or below and the service number corresponds to the service of collecting a plate (2) and, in table information after call, the plate disappears, since this is a case in which the target object (plate) is removed in the service number (2) of Table 6, it is determined to be an intended change, and when there is no significant change of image in the table information after call or a change occurs to another object different from the target object or there is a change of quantity in the target object, it is determined to be an unintended change.

As another example, when waste is detected in table information before call, the waste collection service (4) is called in the service number and the waste disappeared in table information after call, since this is a case in which the target object is removed in the service number (4) of Table 6 below, it is determined to be an intended change, and when there is no change in table information after call or there is another change like a change in the quantity of food or a change in the type of food, it is determined to be an unintended change.

TABLE 6

| | REMOVE | | CHANGE OF |
|---|---|---|---|
| | TARGET | DETECT | QUANTITY |
| SERVICE NUMBER | OBJECT | NEW FOOD | (INCREASE) |
| SERVE NEXT FOOD (1) | 0 | 0 | — |
| COLLECT PLATE (2) | 0 | — | — |
| PROVIDE REFILL (3) | — | — | 0 |
| COLLECT WASTES (4) | 0 | — | — |
| INFORM LOST ITEM (5) | 0 | — | — |

When a result of the change determination unit 141 is an intended change, in order to consider a result of the image recognition unit 120, that is, table information as a reliable state and to enable more services to be recommended, a model reference unit lowers a model reference value by a predesignated value, for example, by a first value, and when it is not an intended change, the model reference unit raises the model reference value by a predesignated value, for example, by a second value to enable a service to be recommended more accurately. The model reference value thus modified may be forwarded to the model storage unit 170 and be used as a model reference value of the image recognition unit 120.

When a result of the change determination unit 141 is an intended change, the relearning data modification unit 143 determines a result of the image recognition unit 120 to be accurate and stores table information before call in the relearning data storage unit 150 as it is, and when a result of the change determination unit 141 is not an intended change, since the result of the image recognition unit 120 has an error, an error of table information before service call is corrected and then stored in the relearning data storage unit 150. According to an embodiment, the relearning data modification unit 143 may modify an error of table information before service call through an expert's tagging input and store the table information before call thus modified through the expert's tagging input in the relearning data storage unit 150. Herein, the expert's tagging may utilize a tagging system in an external cloud sourcing form.

When a preset predetermined amount of relearning data is stored in the relearning data storage unit 150, the model relearning unit 160 relearns a learning model by using the predetermined amount of relearning data and an existing learning model and then delivers the relearned or updated learning model to the model storage unit 170, and thus the relearned learning model is stored in the model storage unit 170. Herein, the model relearning unit 160 may relearn a learning model by various methods of relearning a learning model, and a fine-tuning method may be used to relearn a learning model.

Hereinafter, a device according to an embodiment of the present disclosure will be described by distinguishing two cases: i) the image recognition unit 120 normally functions, and ii) the image recognition unit 120 malfunctions.

i) The Image Recognition Unit 120 Normally Functions

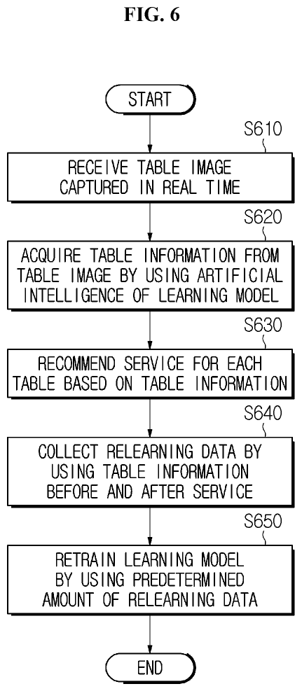

When a new customer sits at table in a restaurant and makes an order, order information is recorded in the table management system 180. If the customer selects a course meal with drink refill, information on the course meal with drink refill, that is, information on the availability of drink refill, course meal, and payment not made is recorded in the table management system 180. Then, when the food ordered by the customer is served and the customer has it, the image receiver 110 receives an image of the table taken by an imaging means during the customer's meal, and the image recognition unit 120 acquires or generates table information from the image of the customer's table by using a pre-learned learning model. For example, if the customer's table image looks like FIG. 5(a), table information as shown in Table 7 below may be acquired.

TABLE 7

| | | | LOCATION | FOOD | |
|---|---|---|---|---|---|
| IMAGE | ORDER | OBJECT TYPE | (x1, y1, x2, y2) | TYPE | QUANTITY |
| [symbol] | 1 2 3 | TABLEWARE (KNIFE) FOOD AND BEVERAGE (FOOD) TABLEWARE (FORK) | 50, 30, 80, 90 100, 30, 120, 80 130, 30, 160, 90 | PASTA | 90 |
| | 4 | FOOD AND BEVERAGE (BEVERAGE) | 180, 40, 210, 80 | WATER | 70 |

Based on the table information acquired as shown in Table 7 above, the service recommendation unit 130 searches for a recommendable service suitable for the table. Herein, when call progress information is checked and there is no call, preset condition information, that is, the conditions of Table 4 above are compared. As the comparison of the conditions of Table 4 shows that no condition matches the table information of Table 7, the process ends with no service recommended to the table.

After such a state continues for a predetermined time, when table information received by the image recognition unit 120 is like FIG. 5(b), the image recognition unit 120 may acquire table information as shown in Table 8 below.

TABLE 8

| | | | LOCATION | FOOD | |
|---|---|---|---|---|---|
| IMAGE | ORDER | OBJECT TYPE | (x1, y1, x2, y2) | TYPE | QUANTITY |
| [symbol] | 1 2 3 | TABLEWARE (KNIFE) FOOD AND BEVERAGE (FOOD) TABLEWARE (FORK) | 50, 20, 80, 95 100, 30, 120, 80 130, 20, 160, 95 | PASTA | 5 |
| | 4 | FOOD AND BEVERAGE (BEVERAGE) | 180, 40 , 210, 80 | WATER | 70 |

When the table information as shown in Table 8 above is acquired, the service recommendation unit 130 records Service 1, Service 2 and Service 3 in a cache as candidates together with time information by referring to Condition 1 of Table 4, and when a time elapses again and there is no significant change at the table, the same table information as in Table 8 may be received. In this case, the service recommendation unit 130 selects the recommended service number 1 by searching for a condition matching Condition 2 of Table 4 based on table information of Table 8 and order information and forwards the service number 1 to a next block, for example, the relearning data collection unit 140 or the service call system 190. Herein, the service recommendation unit 130 forwards the table information before call and the service number in a form like Table 9 below to the relearning data collection unit 140 and forwards the service number to the service call system 190.

TABLE 9
TABLE INFORMATION BEFORE CALL

| | | | LOCATION | FOOD | | SERVICE |
|---|---|---|---|---|---|---|
| IMAGE | ORDER | OBJECT TYPE | (x1, y1, x2, y2) | TYPE | QUANTITY | NUMBER |
| [symbol] | 1 | TABLEWARE (KNIFE) | 50, 20, 80, 95 | | | |
| | 2 | FOOD AND | 100, 30, 120, 80 | PASTA | 5 | 1 |
| | | BEVERAGE (FOOD) | | | | |
| | 3 | TABLEWARE (FORK) | 130, 20, 160, 95 | | | |
| | 4 | FOOD AND BEVERAGE | 180, 40, 210, 80 | WATER | 70 | |
| | | (BEVERAGE) | | | | |

Next, when a new image is input, call progress information is received from the service call system 190 and it is checked whether or not a call is completed. If the call is completed, since it means that a hall manager or staff has been to the table, a process of receiving a new table image and acquiring table information is performed again. That is, a device of the present disclosure acquires table information from a new table image and checks whether or not there is a service call, and when a current call is completed, table information after the service call, table information before the call stored in a cache, and a service number are forwarded to the relearning data collection unit 140.

The relearning data collection unit 140 determines whether or not there is an intended change according to the type classification of Table 6, and when table information like in Table 10 below is acquired according to the table image of FIG. 5(c), since a target object (food and beverage (food)-pasta) is removed from the service number 1 and a new food (fruit) is detected according to the type classification of Table 6 above, it is determined to be an intended change.

TABLE 10

| | | | LOCATION | FOOD | |
|---|---|---|---|---|---|
| IMAGE | ORDER | OBJECT TYPE | (x1, y1, x2, y2) | TYPE | QUANTITY |
| [symbol] | 1 2 | TABLEWARE (KNIFE) FOOD AND BEVERAGE (FOOD) | 50, 20, 80, 95 100, 30, 120, 80 | PASTA | 95 |
| | 3 | TABLEWARE (FORK) | 130, 20, 160, 95 | | |
| | 4 | FOOD AND BEVERAGE (BEVERAGE) | 180, 40, 210, 80 | WATER | 70 |

When there is an intended change based on the determination, the relearning data collection unit 140 lowers a model reference value and stores table information before call itself in the relearning data storage unit 150.

ii) The Image Recognition Unit 120 Malfunctions

When a new customer sits at table in a restaurant and makes an order, order information is recorded in the table management system 180. If the customer selects a course meal with drink refill, information on the availability of drink refill, course meal, and payment not made is recorded in the table management system 180. Then, when the food ordered by the customer is served and the customer has it, the image receiver 110 receives an image of the table taken by an imaging means during the customer's meal, and the image recognition unit 120 acquires or generates table information from the image of the customer's table by using a pre-learned learning model. Due to malfunction of the image recognition unit 120, table information as in Table 11 below may be recognized even during the meal. Table 11 assumes that, while there is still a sufficient amount of drink, the malfunction of the image recognition unit 120 makes the amount of drink recognized to be 5%.

TABLE 11

| | | | LOCATION | FOOD | |
|---|---|---|---|---|---|
| IMAGE | ORDER | OBJECT TYPE | (x1, y1, x2, y2) | TYPE | QUANTITY |
| [symbol] | 1 2 3 | TABLEWARE (KNIFE) FOOD AND BEVERAGE (FOOD) TABLEWARE (FORK) | 50, 30, 80, 90 100, 30, 120, 80 130, 30, 160, 90 | | |
| | 4 | FOOD AND BEVERAGE (BEVERAGE) | 180, 40, 210, 80 | WATER | 5 |

By referring to Condition 1 of Table 4 above, the service recommendation unit 130 stores Service 1, Service 2 and Service 3 as candidates in a cache together with time information. Then, after another elapse of time, the same table information as in Table 11 above may be received. In this case, by referring to the table information of Table 11 and order information, the service recommendation unit 130 selects the recommended service number 3 (refill) matching Condition 2 of Table 4 above, forwards table information before call and the service number to the relearning data collection unit 140 in the form of Table 12, and forwards the service number to the service call system 190.

TABLE 12
TABLE INFORMATION BEFORE CALL

| | | | LOCATION | FOOD | | SERVICE |
|---|---|---|---|---|---|---|
| IMAGE | ORDER | OBJECT TYPE | (x1, y1, x2, y2) | TYPE | QUANTITY | NUMBER |
| [symbol] | 1 | TABLEWARE (KNIFE) | 50, 20, 80, 95 | | | |
| | 2 | FOOD AND | 100, 30, 120, 80 | PASTA | 95 | |
| | | BEVERAGE (FOOD) | | | | |
| | 3 | TABLEWARE (FORK) | 130, 20, 160, 95 | | | |
| | 4 | FOOD AND BEVERAGE | 180, 40, 210, 80 | WATER | 5 | 3 |
| | | (BEVERAGE) | | | | |

Next, when a new image is input, call progress information is obtained from the service call system 190 and it is checked whether or not a call is completed. If the call is completed, since it means that a hall manager or staff has been to the table, a process of receiving a new table image and acquiring table information is performed again. In case the call is generated by an error of the image recognition unit 120, it does not fit the situation so that no intended change occurs to the table.

Accordingly, table information after call, which is acquired from a new table image, table information before call stored in a cache, and the service number are forwarded to the relearning data collection unit 140. The relearning data collection unit 140 determines whether or not there is an intended change according to the type classification of Table 6. If the table information after call is acquired as shown in Table 13 below, an increase in the quantity of target object (drink) should occur in the service number 3 (refill) according to the type classification of Table 6 above, but it is not the case and thus is determined as an unintended change.

TABLE 13

| | | | LOCATION | FOOD | |
|---|---|---|---|---|---|
| IMAGE | ORDER | OBJECT TYPE | (x1, y1, x2, y2) | TYPE | QUANTITY |
| [symbol] | 1 2 3 | TABLEWARE (KNIFE) FOOD AND BEVERAGE (FOOD) TABLEWARE (FORK) | 50, 30, 80, 90 100, 30, 120, 80 130, 30, 160, 90 | | |
| | 4 | FOOD AND BEVERAGE (BEVERAGE) | 180, 40, 210, 80 | WATER | 5 |

In the case of an unintended change, the relearning data collection unit 140 raises a model reference value, and since there is an error in table information before call, modifies the table information before call through expert tagging and then stores the modified information in the relearning data storage unit 150.

When relearning data thus collected exceeds a predetermined amount, the model relearning unit 160 performs relearning and a learning model of the model storage unit 170 is updated.

Thus, a device according to an embodiment of the present disclosure may exempt staffs from walking around a restaurant, minimize contact with customers and provide the customers with services appropriate for the situations of each table through recommendation of table services.

In addition, a device according to an embodiment of the present disclosure may efficiently select and collect relearning data by a method minimizing human intervention in order to mitigate performance degradation caused by a gap between learning data and field data, which occurs in the practical application to service conditions, and provide a table recommendation service with stable performance through relearning of a model based on the collected relearning data.

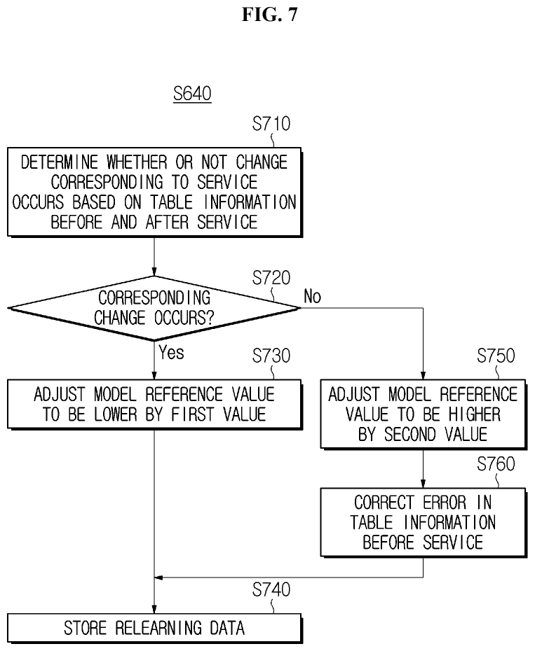

FIG. 6 is a flowchart showing an operation of a table service recommending method according to another embodiment of the present disclosure.

Referring to FIG. 6, a method for recommending a table service according to another embodiment of the present disclosure includes receiving a table image that is captured in real time by an imaging means and acquiring table information from the table image by using an artificial intelligence of a pre-learned learning model (S610, S620).

Herein, at step S620, table information including information on an object on a table (e.g., information on a type and location of the object) and food information (e.g., information on a type and quantity of a food) may be acquired by using the artificial intelligence of the learning model.

According to an embodiment, at step S620, a target object candidate region from a table image and a reliability of each target object candidate region may be calculated by using the artificial intelligence, a target object candidate region with a reliability, which is equal to or greater than a preset model reference value, may be determined as a detection region, and object information including a location of an object and a type of an object and food information including a food type and a food quantity may be acquired through the detection region.

When the table information of the table image is acquired at step S620, a service for each table is recommended based on the acquired table information (S630).

Herein, a recommended service may include at least one of collecting a plate, collecting wastes, serving a food, providing a refill, and informing a lost item.

According to an embodiment, at step S630, a service for a table may be recommended based on table information of the table, order information of the table and call progress information associated with a call of the table. Herein, the order information of the table may be received through the table management system 180, and the call progress information may be received through a service call system. The call process information may have any one value among values corresponding to no call, service call in progress, and completion of service call.

According to another embodiment, at step S630, when there is no call service by a table, a recommendable service may be selected by comparing table information of the table and information on at least one preset condition, and the recommendable service thus selected may be provided as a service of the table.

In addition, for relearning of the learning model by using table information before service call and table information after service call according to a recommended service or a requested service, relearning data is collected, and when a predetermined amount of relearning data is collected, the learning model is relearned using the predetermined amount of relearning data, and thus the performance of the learning mode for acquiring table information may be enhanced (S640, S650).

Herein, at step S640, as illustrated in FIG. 7, whether or not there is a change corresponding to the recommended service or the requested service is determined based on the table information before and after the recommended service or the requested service, and when it is determined that the corresponding change occurs, a model reference value is adjusted to be lower by a first value, and the table information before call itself is stored as relearning data (S710 to S740).

On the other hand, based on a determination result of step S720, when it is determined based on the table information before and after service that no change corresponding to the service occurs, the model reference value is adjusted to be higher by a preset second value, and as the presence of error in the table information before service is recognized, the error in the table information before service is corrected using expert tagging or other means, and then the table information before service thus modified is stored as relearning data (S750, S760, S740).

Although not described in the method of FIG. 5, a method according to an embodiment of the present disclosure may include all the contents described in a device of FIG. 1 to FIG. 4, which is apparent to those who have skill in the art.

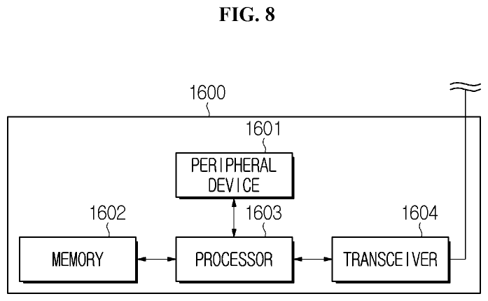

FIG. 8 is a view illustrating a device configuration to which a table service recommendation device according to an embodiment of the present disclosure is applicable.

The table service recommendation device 100 according to an embodiment of the present disclosure of FIG. 1 may be a device 1600 of FIG. 8. Referring to FIG. 8, the device 1600 may include a memory 1602, a processor 1603, a transceiver 1604 and a peripheral device 1601. In addition, for example, the device 1600 may further include another configuration and is not limited to the above-described embodiment. Herein, for example, the device 1600 may be a mobile user terminal (e.g., a smartphone, a laptop, a wearable device, etc.) or a fixed management device (e.g., a server, a PC, etc.).

More specifically, the device 1600 of FIG. 8 may be an exemplary hardware/software architecture such as a table recommendation learning device, a table service providing device and a table information recognition device. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600. In addition, the processor 1603 may be performed by modularizing the functions of the image recognition unit 120, the service recommendation unit 130, the relearning data collection unit 140 and the model relearning unit 160 of FIG. 1.

Herein, the processor 1603 may execute computer-executable commands stored in the memory 1602 in order to implement various necessary functions of the table service recommendation device. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that the table service recommendation device may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for recommending a table service, the method comprising:
receiving a table image that is captured in real time;
acquiring, by using an artificial intelligence of a pre-learned learning model, table information that includes object information and food information of at least one table in the table image; and
recommending, based on the table information, a service for each of the at least one table.

2. The method of claim 1, wherein the acquiring of the table information comprises:
calculating, by using the artificial intelligence, a target object candidate region from a table image and a reliability of the target object candidate region respectively;
determining a target object candidate region with the reliability equal to or greater than a preset model reference value as a detection region; and
acquiring, through the detection region, the object information including a location of an object and a type of an object and food information including a food type and a food quantity.

3. The method of claim 1, wherein the recommending of the service recommends the service for a corresponding table based on table information of the corresponding table, order information of the corresponding table, and call progress information associated with a call of the corresponding table.

4. The method of claim 1, wherein the recommending of the service comprises:
when there is no call service for a corresponding table,
selecting a recommendable service by comparing table information of the corresponding table and information on at least one preset condition; and
providing the selected recommendable service as a service of the corresponding table.

5. The method of claim 4, wherein the recommending of the service further comprises recommending at least one service among collecting a plate, collecting wastes, serving a food, providing a refill, and informing a lost item.

6. The method of claim 2, further comprising:
determining whether or not there is a change corresponding to a recommended service or a requested service, based on table information before and after the recommended service or the requested service; and
adjusting the model reference value to be lower by a preset first value, when it is determined that there is a change corresponding to the recommended service or the requested service, and adjusting the model reference value to be higher by a preset second value, when it is determined that there is no change corresponding to the recommended service or the requested service.

7. The method of claim 1, further comprising:
collecting relearning data by using service information for each of the at least one table and table information before and after the service corresponding to the service information; and
relearning the learning model by using the relearning data, when a predetermined amount of the relearning data is collected,
wherein the acquiring of the table information acquires the table information by using the relearned learning model.

8. The method of claim 7, wherein the collecting of the relearning data collects the relearning data, when no change corresponds to the service information based on the table information before and after the service corresponding to the service information.

9. The method of claim 8, wherein the collecting of the relearning data collects the relearning data by correcting an error in the table information before the service, when no change corresponds to the service information.

10. An apparatus for recommending a table service, the apparatus comprising:
an image receiver configured to receive a table image that is captured in real time;
an image recognition unit configured to acquire, by using an artificial intelligence of a pre-learned learning model, table information that includes object information and food information of at least one table in the table image; and
a service recommendation unit configured to recommend, based on the table information, a service for each of the at least one table.

11. The apparatus of claim 10, wherein the image recognition unit is further configured to:
calculate a target object candidate region from a table image and a reliability of the target object candidate region respectively by using the artificial intelligence,
determine a target object candidate region with a reliability equal to or greater than a preset model reference value, as a detection region, and
acquire, through the detection region, the object information including a location of an object and a type of an object and the food information including a food type and a food quantity.

12. The apparatus of claim 10, wherein the service recommendation unit is further configured to recommend a service for a corresponding table based on table information of the corresponding table, order information of the corresponding table, and call progress information associated with a call of the corresponding table.

13. The apparatus of claim 10, wherein the service recommendation unit is further configured to, when there is no call service for a corresponding table,
select a recommendable service by comparing table information of the corresponding table and information on at least one preset condition, and
provide the selected recommendable service as a service of the corresponding table.

14. The apparatus of claim 13, wherein the service recommendation unit is further configured to recommend at least one service among collecting a plate, collecting wastes, serving a food, providing a refill, and informing a lost item.

15. The apparatus of claim 11, further comprising:
a change determination unit configured to determine whether or not there is a change corresponding to a recommended service or a requested service, based on table information before and after the recommended service or the requested service; and
a model reference adjustment unit configured to adjust the model reference value to be lower by a preset first value, when it is determined that there is a change corresponding to the recommended service or the requested service, and to adjust the model reference value to be higher by a preset second value, when it is determined that there is no change corresponding to the recommended service or the requested service.

16. The apparatus of claim 10, further comprising:
a relearning data collection unit configured to collect relearning data by using service information for each of the at least one table and table information before and after the service corresponding to the service information; and
a relearning unit configured to relearn the learning model by using the relearning data, when a predetermined amount of the relearning data is collected,
wherein the image recognition unit is further configured to acquire the table information by using the relearned learning model.

17. The apparatus of claim 16, wherein the relearning data collection unit is further configured to collect the relearning data, when no change corresponds to the service information based on the table information before and after the service corresponding to the service information.

18. The apparatus of claim 17, wherein the relearning data collection unit is further configured to collect the relearning data by correcting an error in the table information before the service, when no change corresponds to the service information.
